(19) United States
(12) Patent Application Publication
(10) Pub. No.: US 2005/0011903 A1
(43) Pub. Date: Jan. 20, 2005

(54) Container handle

(76) Inventors: Wen-Wei Su, Hsinchu (TW); Kuei-Hung Chen, Taipei (TW); Yu-Chien Hsiao, Taoyuan (TW); Li-Chung Hsu, Taoyuan (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/891,282

(22) Filed: Jul. 14, 2004

(30) Foreign Application Priority Data
Jul. 18, 2003 (TW) 092119752

(51) Int. Cl. A01K 89/00

(52) U.S. Cl. 220/762

(57) ABSTRACT

A handle structure is held by a user to move a reacting container such as a fermentation tank. The reacting container includes a hollow container body, a cover and a plurality of cannulae penetrating through the cover for communicating the hollow container body with the external. The handle structure includes a handle member standing upright for a user to exert a holding force thereon in a working mode and drooping away from the cannulae in a resting mode; and a clutch member rotatably coupled to the handle member, and optionally rotated relative to the handle member to switch between a first mode allowing the handle member to enter the resting mode and a second mode prohibiting the handle member from entering the resting mode.

### FIELD OF THE INVENTION

The present invention relates to a container handle, and more particularly to a handle of a movable reactor such as a fermentation tank.

### BACKGROUND OF THE INVENTION

Before the fermentation process is performed in a well-conditioned reaction room, the fermentation tank as well as the fermentation broth usually needs to be sterilized first to avoid contamination of the product by undesired microorganisms. For facilitating the movement of the fermentation tank between the reaction room and the sterilization room, handles are provided on the fermentation tank for user's hands to work on. FIGS. 1A and 1B schematically show conventional fermentation tanks with two different handles, respectively.

FIG. 1A illustrates the arrangement of handles on the top surface of the cover 101 of the fermentation tank 10. It is known that during the fermentation process, various inlets are required for feeding reacting and conditioning material, e.g. nutrient media, carbon, gas, energy source, etc. In addition, the fermentation conditions and products need to be monitored frequently via a sampling line for quality control. In other words, a variety of lines 102 communicating the fermentation tank 10 with the external are arranged on the cover 101 of the fermentation tank 10 and the operator has a lot of work on the cover 101. Therefore, the handles 103 fixed uprightly on the top surface of the cover 101, as shown in FIG. 1A, occupy too much space and will baffle the operator's work on the cover 101.

FIG. 1B illustrates the arrangement of bar-shaped handles mounted to side walls of the cover 111 of the fermentation tank 11. When the fermentation tank 11 is to be moved, the handles 112 are pivoted to and stopped at the position A for the operator to exert the raising force. After the fermentation tank 11 is positioned, the handles 112 are pivoted to the position B to minimize the occupied space. Since the sterilization of the fermentation tank 11 is usually performed in a sterilization room, which is usually a high-temperature tank having a diameter only slightly larger than the diameter of the fermentation tank 11, the pivoting operation of the handles 112 may be performed at the risk of burn.

### SUMMARY OF THE INVENTION

The present invention provides a handle having an adapted configuration for raising a container, and the configuration, after the container is settled, can be changed to vacate the operating space over the cover.

A first aspect of the present invention relates to a handle structure to be held for moving a container. The handle structure comprises a base member fixed onto a surface of a container to be moved; a handle member pivotal relative to the base member; a clutch member coupled to the base member and the handle member, and optionally switched between a first mode permitting the pivoting operation of the handle member relative to the base member and a second mode prohibiting the pivoting operation of the handle member relative to the base member.

Preferably, the clutch member is pivotally coupled to the base member and rotatably coupled to the handle member.

In an embodiment, the clutch member is switched from the first mode to the second mode by being rotated relative to the handle member to form steric hindrance in front of the handle member in a specified direction. For example, when the handle member has an arch shape with a pillar thereof coupled to the clutch member, the specified direction is preferably a normal direction of the arch plane.

In an embodiment, the clutch member and the base member are linked together with two opposite bridging plates and two connecting pins, one of the connecting pins penetrates through the bridging plates and the clutch member, and the other of the connecting pins penetrates through the bridging plates and the base member. Preferably, it is the bridging plates rotated to lie in the specified direction to form the steric hindrance in the second mode

In an embodiment, the clutch member has a hollow main portion for receiving therein the pillar of the handle member and two posts supporting the hollow main portion and disposed at two opposite sides of the base member. The two posts are rotated to lie in the specified position to form the steric hindrance in the second mode.

In an embodiment, the handle member droops by pivoting the clutch member relative to the base member in the first mode.

In an embodiment, the handle member is allowed to be pivotally switched between a working configuration and a resting configuration when the clutch member is in the first mode and is kept in the working configuration when the clutch member is in the second mode. For example, the working configuration is that the handle member stands upright over the container and the resting configuration is that the handle member droops.

Preferably, the handle member is positioned on an upper surface of a cover of the container via the base member.

In an embodiment, the base member comprises a pillar portion for penetrating through a cover of the container and rendering a protrudent portion; and a confining element for attaching the pillar portion onto the cover. For example, the confining element is screw means.

Alternatively, the base member comprises a pillar portion for penetrating through a cover of the container and rendering a protrudent portion; a first confining element connected to the pillar portion at a first side of the cover to prevent the pillar portion from escaping from the cover; and a second confining element connected to the pillar portion at a second side of the cover opposite to the first side after the pillar portion penetrates through the cover to prevent the pillar portion from escaping from the cover. For example, the first confining element is a flange around the pillar portion for sustaining against the cover, and the second confining element is a retaining ring for clamping the protrudent portion of the pillar portion and sustaining against the cover.

In an embodiment, the pillar portion has a first traverse through hole in the protrudent portion, and the first traverse through hole is aligned with a second traverse through hole of the clutch member for concatenating the clutch member and the base member with a connecting pin penetrating through the first and second traverse through holes. By this way, the clutch member is allowed to be pivoted and transmit the handle member to pivot relative to the base portion in the first mode.

In an embodiment, the handle member and the clutch member are rotatably coupled to each other with screw means.

According to a second aspect of the present invention, the handle structure to be held for moving a reacting container, which comprises a hollow container body, a cover and a plurality of cannulae penetrating through the cover for communicating the hollow container body with the external, comprises a handle member standing upright for a user to exert a holding force thereon in a working mode and drooping away from the cannulae in a resting mode; and a clutch member rotatably coupled to the handle member, and optionally rotated about the handle member to switch between a first mode allowing the handle member to enter the resting mode and a second mode prohibiting the handle member from entering the resting mode.

In an embodiment, the clutch member is pivotally coupled to a base member, which is fixed onto the cover, and switched from the first mode to the second mode by being rotated about the handle member to form steric hindrance in front of the handle member in a specified direction.

In an embodiment, the handle member is pivoted relative to the base member to droop by pivoting the clutch member relative to the base member in the first mode.

In an example, the reacting container is a fermentation tank.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a perspective diagram schematically showing a conventional fermentation tank with fixed handles;

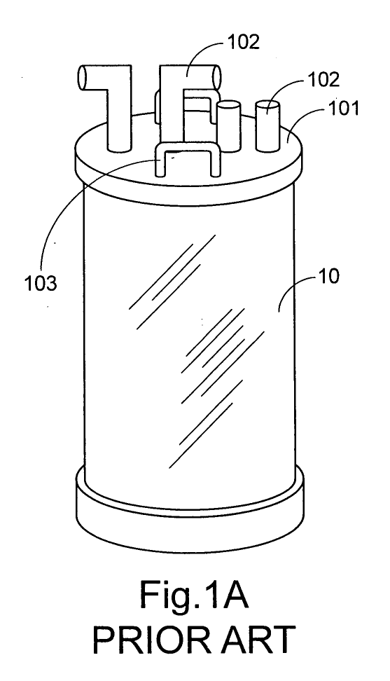

FIG. 1B is a perspective diagram schematically showing another conventional fermentation tank with side bar handles;

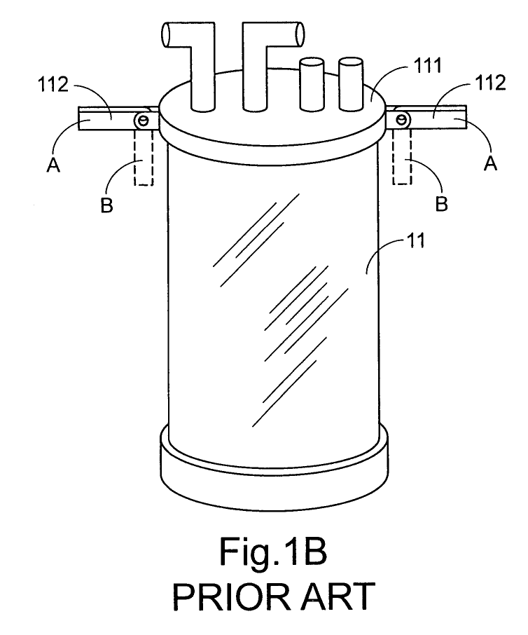

FIG. 2A is a perspective diagram schematically showing the working configuration of a handle structure according to an embodiment of the present invention;

FIG. 2B is a perspective diagram schematically showing the resting configuration of the handle structure of FIG. 2A;

FIG. 3 is a schematic resolving diagram of the handle structure of FIG. 2A;

FIG. 4A is a cross-sectional view of an embodiment of a base member having penetrated through the cover;

FIG. 4B is a top plane view of the base member of FIG. 4A;

FIG. 5 is a perspective diagram viewed from the bottom of the structure for schematically showing the coupling of the clutch member to the handle member;

FIG. 6 is a perspective diagram schematically showing an enlarged view of the clutch member of the handle structure of FIG. 2A;

FIG. 7A is a side view of a handle structure schematically showing the handle-bending-allowing mode of the clutch member according to another embodiment of the present invention; and

FIG. 7B is a side view of the handle structure of FIG. 7A schematically showing the handle-bending-prohibiting mode of the clutch member.

### DETAILED DESCRIPTION OF THE PREFERRED EMBODIMENT

For moving a reacting container such as a fermentation tank or any other container requiring to work over the container, a configuration-changeable handle is provided according to the present invention.

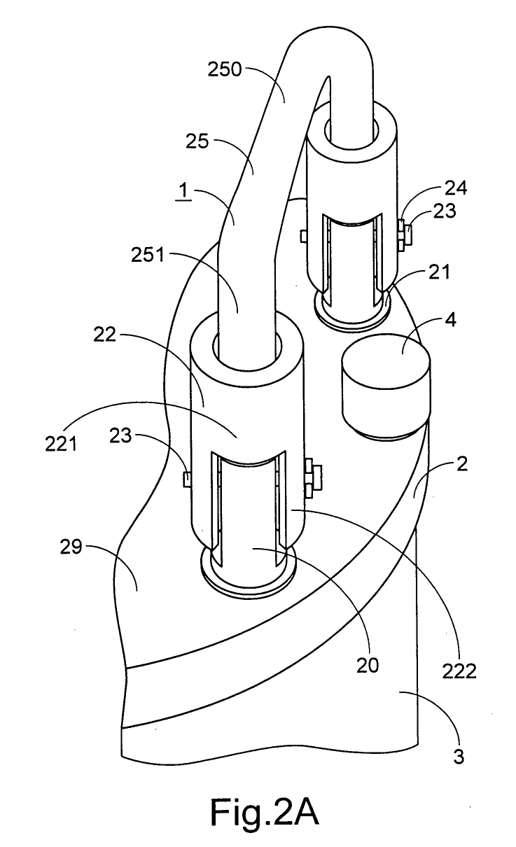

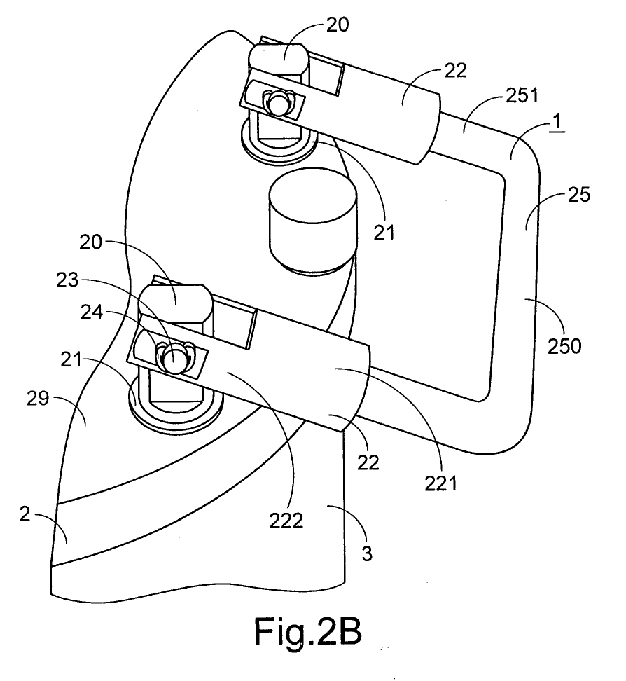

A fermentation tank with a handle structure according to an embodiment of the present invention is illustrated in FIGS. 2A and 2B. The handle structure 1 is mounted to a cover 2 of the fermentation tank. The cover 1 is used for covering a hollow tank body 3 from the external while a plurality of cannulae 4 communicate the hollow tank body 3 with the external for feeding reacting and conditioning material, e.g. nutrient media, carbon, gas, energy source, etc. into the tank body 3 or sampling products from the tank body 3. When the fermentation tank is to be moved, for example to a sterilization room, the handle structure 1 is fixed in a working mode, i.e. stands upright over the cover 2, so that the user can hold the handle 1 to move the tank 3. On the other hand, when the fermentation tank is settled (not to be moved temporarily) and for example various inlets are to be introduced into the tank body 3 via the cannulae 4, the handle structure 1 is preferably bent down or drooped, as shown in FIG. 2B, to vacate some space over the cover 2 so as not to barrier the feeding or sampling operation.

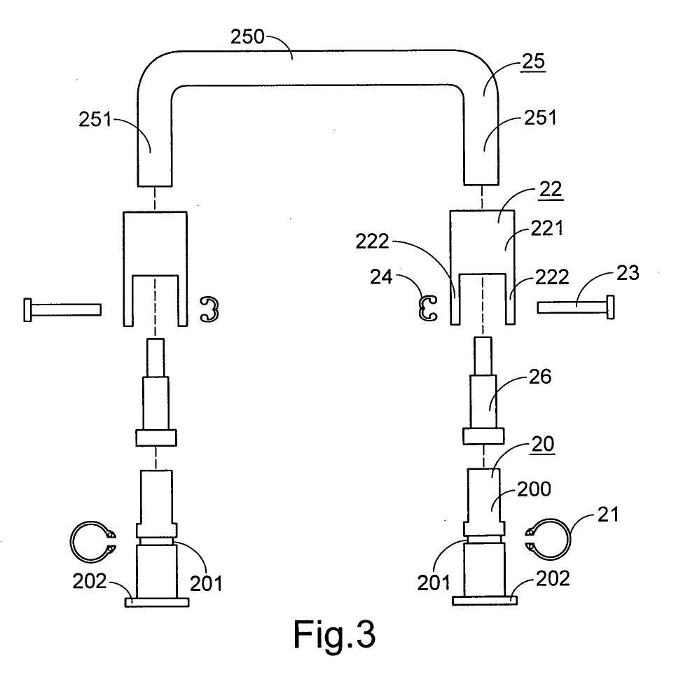

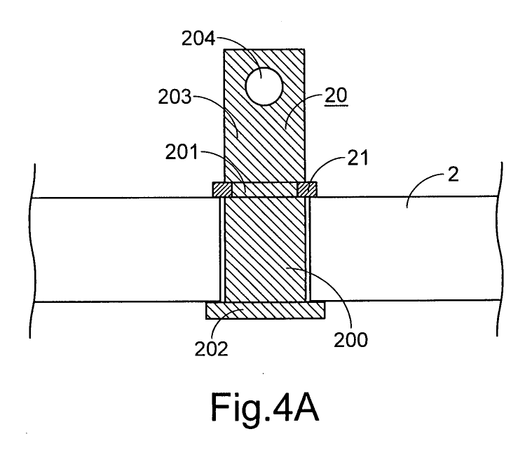

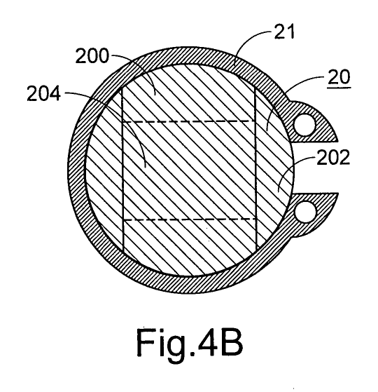

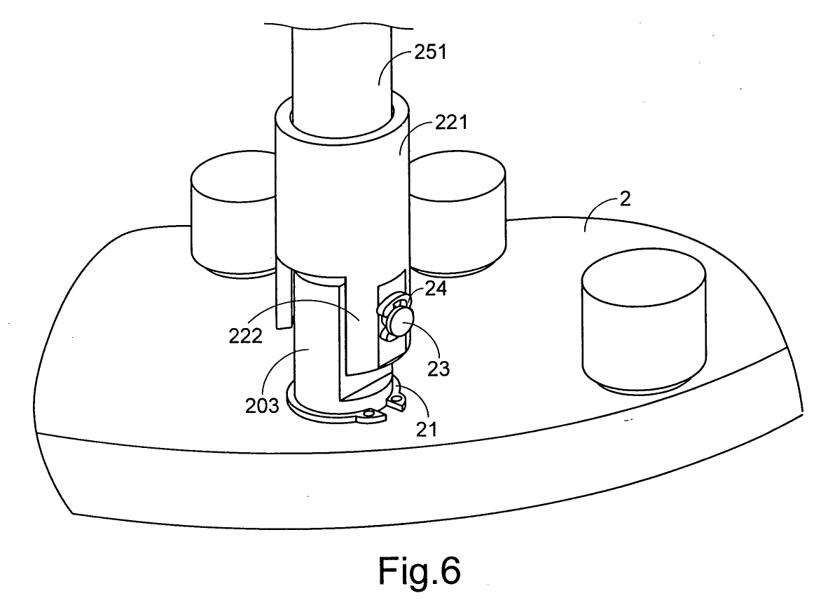

An assembling embodiment of the handle structure 1 will be illustrated hereinafter with reference to the resolving diagram of FIG. 3 and the assembled diagrams of FIGS. 2A, 2B and 6. The handle structure 1 includes a base member 20, a clutch member 22 and a handle member 25. The base member 20 has a pillar portion 200 penetrating through the cover 2 from the lower surface (not shown) of the cover 2, a neck portion 201 in the middle of the pillar portion 200 and a flange portion 202 around an end of the pillar portion 200. The base member 20 is fixed onto the upper surface 29 of the cover 2 with the flange portion 202 sustaining against the lower surface of the cover 2 and a retaining ring 21 engaging with the neck portion 201 and sustaining against the upper surface of the cover 2, as shown in FIG. 4A. FIG. 4A is a cross-sectional view of the base member 20 having penetrated through the cover 2. Alternatively, the base member 20 can be fixed onto the cover 2 via screw means. It is to be noted that the base member 20, although fixed onto the cover 2, should be kept rotatable in the through hole of the cover 2. In the protrudent portion 203 protruding from the upper surface 29 of the cover 2, a traverse through hole 204 is provided. A top plane view of the base member 20 is shown in FIG. 4B.

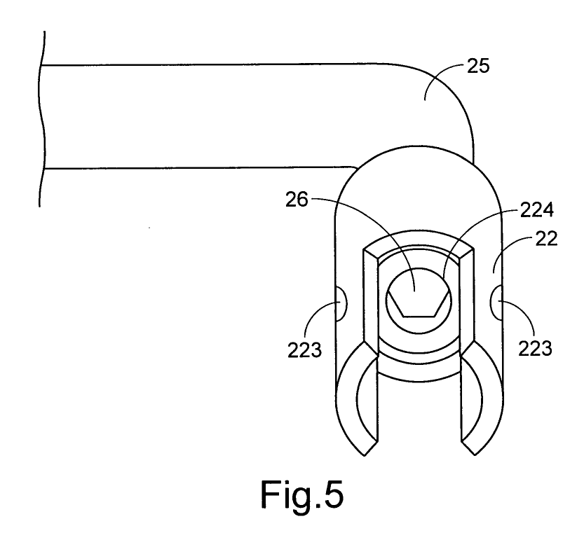

The clutch member 22 has a hollow main portion 221 and two posts 222 supporting the hollow main portion 221. In each of the posts 222, a traverse through hole 223 (FIG. 5) is provided. In addition, another through hole 224 is provided in the bottom of the hollow main portion 221. For assembling the clutch member 22 with the base member 30, the posts 222 of the clutch member 22 is sleeved on the base portion 20 with the traverse through holes 223 disposed at opposite sides of and aligned with the traverse through hole 204 of the base member 20. A connecting pin 23 are then inserted into the through holes 223 and 204 and secured with a stopper ring 24 for concatenating the clutch member 22 and the base member 20 together while allowing the clutch member 22 to pivot about the connecting pin 23 relative to the base member 20. The stopper 24, for example, can be a screw hold, a retaining ring, a split pin, a key groove or any other suitable pin-retaining element.

The handle member 25 for example has an arch shape, and comprises a holding portion 250 and two pillars 251. Each of the pillars 251 has a threaded hole (not shown) at an end thereof to be aligned with the through hole 224 of one clutch member 22. When the pillar 251 is received in the hollow main portion 221 of the clutch member 22, the pillar 251 is fixed to the bottom of the hollow main portion 221 with screw means 26. It is to be noted that the pillar 251 and the hollow main portion 221 should be kept rotatable relative to each other. The assembled handle structure 1 is shown in FIGS. 2A, 2B or 6.

For keeping the handle member 25 standing upright in the working mode, the clutch member 22 is rotated along with the base member 20 to have the posts 222 lie in the normal direction of the arch plane of the handle member 25. By this way, the posts 222 form steric hindrance at both sides of the handle member 225 so as to prohibit the pivoting operation of the clutch member 22 and the handle member 25 about the connecting pin 23 relative to the base member. On the other hand, for allowing the handle structure to enter the resting mode, the clutch member 22 is rotated along with the base member 20 to move the posts 251 away from the bending path of the handle member 25. Meanwhile, the handle member 25 can freely droop with the pivoting operation of the clutch member 22 about the connecting pin 23 relative to the base member 20.

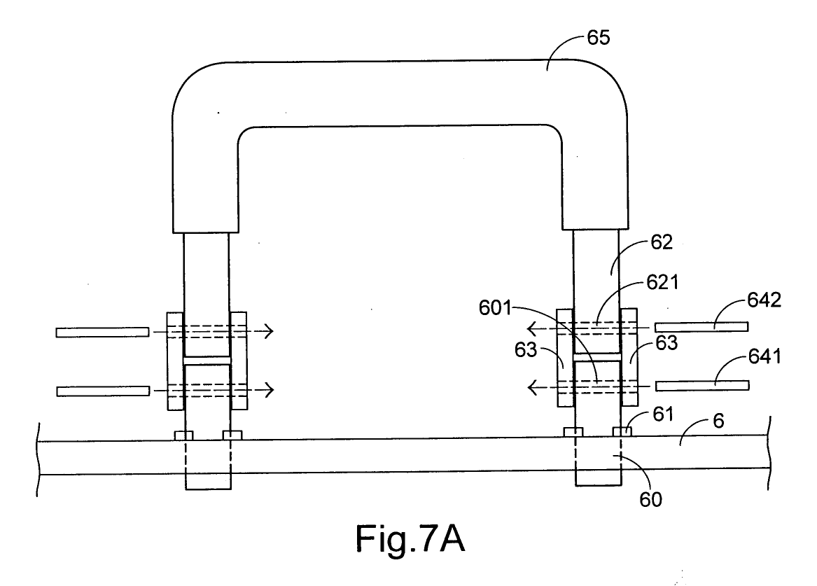

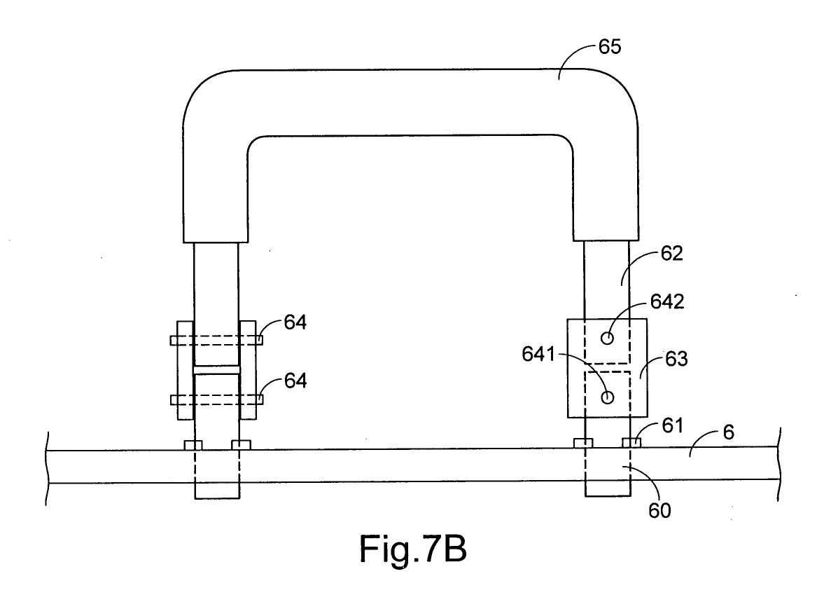

A handle structure according to another embodiment of the present invention is illustrated with FIGS. 7A and 7B. In the handle structure as shown, a base member 60 is rotatably fixed to the cover 6 of a container via a coupling member 61. A clutch member 62 is pivotally coupled to the base member 60 via two opposite bridging plates 63 and two pins 641 and 642. The pin 641 penetrates through the bridging plates 63 and a traverse through hole 601 of the base member 60 and the pin 642 penetrates through the bridging plates 63 and a traverse through hole 621 of the clutch member 62. The handle member 65 is coupled to the clutch member 62 via screw means and allows the clutch member 62 to rotate therein. FIG. 7A illustrates a first mode of the clutch member 62, wherein the bridging plates 63 are rotated away from the bending path of the handle member 65. Accordingly, the handle member 65 can be transmitted to bend with the pivoting operation of the clutch member 62 about the pins 641 and/or 642 relative to the base portion 60. FIG. 7B illustrates a second mode of the clutch member 65, wherein the bridging plates 23 at one or both sides of the handle member 65 are rotated with the base member 20 to orient a specified direction as shown in FIG. 7B, where the bending operation of the handle member 25 is hindered by the bridging plates 63. Therefore, according to the present invention, the handle structure can be easily operated to have a working configuration like FIG. 2A or a resting configuration like FIG. 2B.

By using the handle structure according to the present invention in a fermentation tank or any other suitable container, the movement of the container can be easily achieved, and the operation performed over the cover can be performed smoothly. Further, by arranging the handle structure on the upper surface of the cover, the risk of burn can be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A handle structure to be held for moving a container, comprising:
a base member fixed onto a surface of a container to be moved;
a handle member pivotal relative to said base member;
a clutch member coupled to said base member and said handle member, and optionally switched between a first mode permitting the pivoting operation of said handle member relative to said base member and a second mode prohibiting the pivoting operation of said handle member relative to said base member.

2. The handle structure according to claim 1 wherein said clutch member is pivotally coupled to said base member and rotatably coupled to said handle member.

3. The handle structure according to claim 2 wherein said clutch member is switched from said first mode to said second mode by being rotated relative to said handle member to form steric hindrance in front of said handle member in a specified direction.

4. The handle structure according to claim 3 wherein said clutch member and said base member are linked together with two opposite bridging plates and two connecting pins, one of said connecting pins penetrates through said bridging plates and said clutch member, and the other of said connecting pins penetrates through said bridging plates and said base member.

5. The handle structure according to claim 4 wherein said bridging plates are rotated to lie in said specified direction to form said steric hindrance in said second mode.

6. The handle structure according to claim 3 wherein said handle member has an arch shape with a pillar thereof coupled to said clutch member.

7. The handle structure according to claim 6 wherein said clutch member has a hollow main portion for receiving therein said pillar of said handle member and two posts supporting said hollow main portion and disposed at two opposite sides of said base member, and said two posts are rotated to lie in said specified position to form said steric hindrance in said second mode.

8. The handle structure according to claim 2 wherein said handle member is pivoted relative to said base member by pivoting said clutch member relative to said base member in said first mode.

9. The handle structure according to claim 1 wherein said handle member is allowed to be pivotally switched between a working configuration and a resting configuration when said clutch member is in said first mode and is kept in said working configuration when said clutch member is in said second mode.

10. The handle structure according to claim 9 wherein said working configuration is that said handle member stands upright over said container and said resting configuration is that said handle member droops.

11. The handle structure according to claim 1 wherein said handle member is positioned on an upper surface of a cover of said container via said base member.

12. The handle structure according to claim 1 wherein said base member comprises:
a pillar portion for penetrating through a cover of said container and rendering a protrudent portion; and
a confining element for attaching said pillar portion onto said cover.

13. The handle structure according to claim 1 wherein said confining element is screw means.

14. The handle structure according to claim 1 wherein said base member comprises:
a pillar portion for penetrating through a cover of said container and rendering a protrudent portion;
a first confining element connected to said pillar portion at a first side of said cover to prevent said pillar portion from escaping from said cover; and
a second confining element connected to said pillar portion at a second side of said cover opposite to said first side after said pillar portion penetrates through said cover to prevent said pillar portion from escaping from said cover.

15. The handle structure according to claim 14 wherein said first confining element is a flange around said pillar portion for sustaining against said cover.

16. The handle structure according to claim 14 wherein said second confining element is a retaining ring for clamping said protrudent portion of said pillar portion and sustaining against said cover.

17. The handle structure according to claim 14 wherein said pillar portion has a first traverse through hole in said protrudent portion, and said first traverse through hole is aligned with a second traverse through hole of said clutch member for concatenating said clutch member and said base member with a connecting pin penetrating through said first and second traverse through holes, thereby allowing said clutch member to be pivoted and transmit said handle member to pivot relative to said base portion in said first mode.

18. The handle structure according to claim 1 wherein said handle member and said clutch member are rotatably coupled to each other with screw means.

19. A handle structure to be held for moving a reacting container, said reacting container comprising a hollow container body, a cover and a plurality of cannulae penetrating through said cover for communicating said hollow container body with the external, said handle structure comprising:
a handle member standing upright for a user to exert a holding force thereon in a working mode and drooping away from said cannulae in a resting mode; and
a clutch member rotatably coupled to said handle member, and optionally rotated relative to said handle member to switch between a first mode allowing said handle member to enter said resting mode and a second mode prohibiting said handle member from entering said resting mode.

20. The handle structure according to claim 19 wherein said clutch member is pivotally coupled to a base member, which is fixed onto said cover, and switched from said first mode to said second mode by being rotated about said handle member to form steric hindrance in front of said handle member in a specified direction.

21. The handle structure according to claim 20 wherein said handle member is pivoted relative to said base member to droop by pivoting said clutch member relative to said base member in said first mode.

22. The handle structure according to claim 19 wherein said reacting container is a fermentation tank.
